(19) United States
(12) Patent Application Publication
(10) Pub. No.: US 2025/0247323 A1
(43) Pub. Date: Jul. 31, 2025

(54) NETWORK-ON-CHIP REGION-BASED ROUTING TABLE GENERATION METHOD

(71) Applicant: SKYECHIP SDN BHD, BAYAN LEPAS (MY)

(72) Inventors: Siew Chin LIM, BAYAN LEPAS (MY); Yin Chong HEW, BAYAN LEPAS (MY); Chee Hak TEH, BAYAN LEPAS (MY)

(73) Assignee: SKYECHIP SDN BHD, BAYAN LEPAS (MY)

(21) Appl. No.: 18/787,936

(22) Filed: Jul. 29, 2024

(30) Foreign Application Priority Data
Jan. 31, 2024 (MY) PI2024000695

(51) Int. Cl. H04L 45/121; H04L 45/00; H04L 45/122

(52) U.S. Cl. CPC H04L 45/121; H04L 45/122; H04L 45/22; H04L 45/34

(57) ABSTRACT

The present invention relates to a computer-implemented method of generating a Network-on-Chip routing table, said method comprising the steps of: identifying source and destination by coordinates; sorting source-destination list based on user-input constraints; iterating source-destination pairs in the sorted source-destination list to find a shortest routing path from the source to the destination; splitting each source-destination pair to multiple sub source-destination pairs based on one of the user-input constraints; iterating each of the sub source-destination pairs to find a shortest routing path in a sub source-destination list; creating routing table for each sub source-destination pair based on the user-input constraints; combining the routing tables of sub source-destination pairs to generate a source-destination pairs routing table; performing routing table deadlock detection before proceeding to generate a routing table for next source-destination pair; wherein the user-input constraints comprising desired throughputs, desired latency, number of router-turns and region restriction for routing; and wherein performing deadlock analysis and rerouting the source-destination pair if deadlock is detected.

### CROSS-REFERENCE TO RELATED APPLICATION

This application claims priority to and the benefit of Malaysian Patent Application No. PI2024000695 filed in the Malaysian Intellectual Property Office on Jan. 31, 2024, the entire contents of which are incorporated herein by reference in its entirety.

### TECHNICAL FIELD

The present invention relates to an efficient and scalable region-based method to generate a deadlock-free routing table without exploring all possible routes in a weighted graph. The region-based method predicts shortest path distance and possible region based on source and destination coordinates in the graph and directly find the shortest path within the possible region.

### BACKGROUND ART

Numerous routing methods are being developed to address the limitations of typical shortest path algorithms in network routing, particularly within conventional Network-on-Chip architectures. Typical shortest path algorithms in network routing present numerous challenges due to inherent limitations. They often determine the shortest path by exhaustively exploring all possible routes within the weighted graph, leading to significant memory and runtime consumption. These algorithms calculate distances solely when visiting adjacent nodes, potentially resulting in wasted effort exploring incorrect directions. Moreover, their weight calculations might not align accurately with the intricate constraints of Network-on-Chip routing tables, which are crucial for meeting specific requirements like throughput, latency, and router-turns. Additionally, these algorithms do not inherently address network or protocol deadlocks, further complicating their practical application in routing scenarios. Hence, a method to find the shortest path in Network-on-Chip architecture without visiting all possible routes is needed to further enhance runtime and memory consumption.

There have been a number of solutions provided for finding the shortest path in Network-on-Chip architecture, in which few of them are discussed below:

U.S. Pat. No. 8,819,616 B2 disclosed a system on chip (SoC) that can include a plurality of blocks of substantially non-uniform shapes and dimensions, a plurality of routers, and a plurality of links between routers. The plurality of blocks and the plurality of routers are interconnected by the plurality of links using a Network-on-Chip architecture with a sparse mesh topology. The sparse mesh topology involves a sparsely populated mesh which is a subset of a full mesh having one or more of the plurality of routers or links removed. The plurality of blocks communicates among each other by routing messages over the remaining ones of the plurality of routers and links of the sparse mesh.

U.S. Pat. No. 9,507,745 B1 disclosed low latency dynamic route selection communicating among cores in a computing system comprising a plurality of cores, each core comprising a processor and a switch, includes: routing a packet from a core or from a device coupled to at least one core to a destination over a route including one or more cores, with an order of dimensions associated with the route being selected dynamically upon construction of the packet; routing the packet to a first core in the route over the first selected dimension; and routing the packet from the first core to the destination over the second dimension.

Rickard Holsmark, Deadlock Free Routing in Mesh Networks on Chip with Regions, Linkoping Studies in Science and Technology, Thesis No. 1410, September 2009 studies some network aspects which are characteristic to Network-on-Chip systems. One is the issue of area wastage in Network-on-Chip due to cores of various sizes. The study elaborates on using oversized regions in regular mesh Network-on-Chip and identify several new design possibilities. This study also offers a methodology for designing topology agnostic, deadlock free, highly adaptive application specific routing algorithms. The methodology exploits information about communication among tasks of an application. This is used in the analysis of deadlock freedom, such that fewer deadlock preventing routing restrictions are required. The study further proposes that the region concept can be extended for supporting reuse of a predesigned Network-on-Chip as a component in a larger hierarchical Network-on-Chip.

Ville Rantala et al, Network on Chip Routing Algorithms, TUCS Technical Report, No 779, August 2006 proposed Network on Chip implementations that utilize packet switching and employ wormhole network flow control. This method results in lower latencies and reduced buffer memory requirements compared to other flow control techniques. The prevailing routing algorithm is deterministic source routing, yet there have been proposals for alternative implementations. These include deterministic destination-tag routing and adaptive algorithms like turn around and hot-potato routing. Additionally, mesh and fat tree are the most popular network topologies, while other topologies have seen limited application. The majority of proposed router architectures remain deterministic. As systems decrease in size and move towards nanoscale development, the demand for fault-tolerant systems becomes crucial. Adaptive implementations are generally more easily modified to be fault-tolerant compared to the rigid, oblivious ones.

Nevertheless, the references described above and other existing techniques still suffer from a number of problems of which the objectives and features of the present invention attempts to address. For example, Network-on-Chip technology dealing with runtime and memory consumption which can affect the efficiency in finding the shortest path without exploring all possible path. Moreover, deadlock is also an issue showing that the routing are still far from advanced. Therefore, it can be seen that there is a need to provide an alternative method to find the shortest path in Network-on-Chip architecture without visiting all possible route.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

It is an objective of the present invention to find the shortest path from initiator to target in Network-on-Chip architecture without visiting all possible routes.

It is also an objective of the present invention to utilize user-input constraints including desired throughput, desired latency, desired maximum router turns and desired link constraints in generating a Network-on-Chip routing table.

It is also an objective of the present invention to provide a deadlock-free routing table generation method.

Accordingly, these objectives may be achieved by following the teachings of the present invention. The present invention relates to a computer-implemented method of generating a Network-on-Chip routing table, said method comprising the steps of: identifying source and destination by coordinates; sorting source-destination list based on user-input constraints; iterating source-destination pairs in the sorted source-destination list to find a shortest routing path from the source to the destination; splitting each source-destination pair to multiple sub source-destination pairs based on one of the user-input constraints; iterating each of the sub source-destination pairs to find a shortest routing path in a sub source-destination list; creating routing table for each sub source-destination pair based on the user-input constraints; combining the routing tables of sub source-destination pairs to generate a source-destination pairs routing table; performing routing table deadlock detection before proceeding to generate a routing table for next source-destination pair; wherein the user-input constraints comprising desired throughputs, desired data travelling latency, number of router-turns and region restriction for routing; and wherein performing deadlock analysis and rerouting the source-destination pair if deadlock is detected.

The foregoing and other objects, features, aspects and advantages of the present invention will become better understood from a careful reading of a detailed description provided herein below with appropriate reference to the accompanying drawings.

### BRIEF DESCRIPTION OF THE ACCOMPANYING DRAWING

So that the manner which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 is a flowchart illustrating a computer-implemented method of generating a Network-on-Chip routing table in accordance with an embodiment of the present invention;

FIG. 2 illustrates a Network-on-Chip architecture example in accordance with an embodiment of the present invention;

FIG. 3 illustrates a Network-on-Chip architecture with number of hops, router-turns and restricted region based on coordinates in accordance with an embodiment of the present invention;

FIG. 4 illustrates a Network-on-Chip architecture with criteria to select next path in accordance with an embodiment of the present invention;

FIG. 5 is a flowchart illustrates a region-based routing algorithm in accordance with an embodiment of the present invention;

FIG. 6 illustrates a Network-on-Chip architecture during rerouting of current router in accordance with an embodiment of the present invention;

FIG. 7 illustrates an expansion of restricted region in Network-on-Chip architecture in accordance with an embodiment of the present invention;

FIG. 8 illustrates a dependency graph in a deadlock detection in accordance with an embodiment of the present invention;

FIG. 9 illustrates a rerouting deadlock detected path in accordance with an embodiment of the present invention; and

FIG. 10 is a flowchart illustrates a process of deadlock analysis and reroute in accordance with an embodiment of the present invention.

### DETAILED DESCRIPTION OF THE PREFERRED EMBODIMENT

While the present invention is described herein by way of example using embodiments, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawing and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa. The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

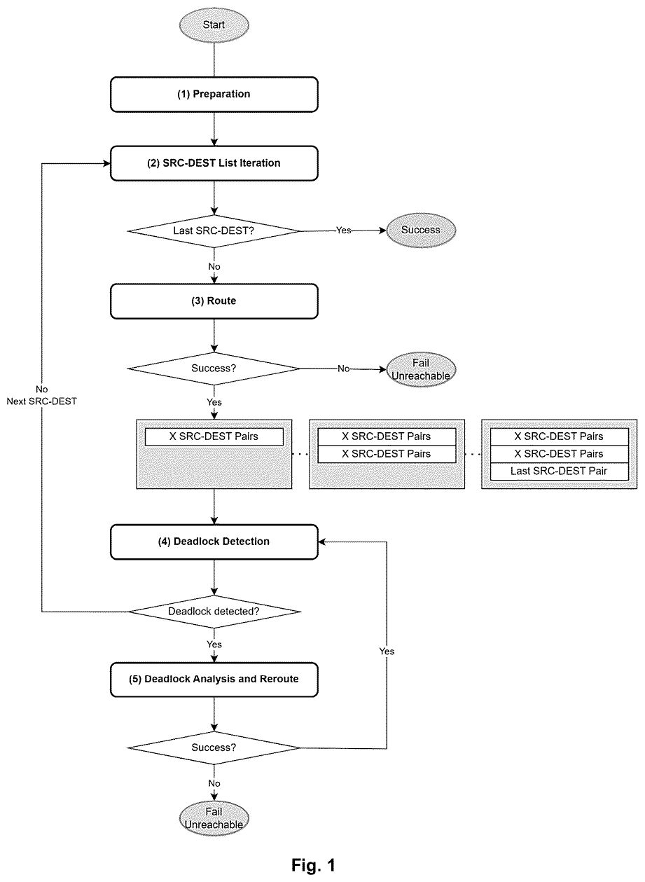

Referring to the drawing as shown in FIGS. 1 to 10, the present invention will now be described in more detail.

The present invention relates to a computer-implemented method of generating a Network-on-Chip routing table, said method comprising the steps of: identifying source and destination by coordinates; sorting source-destination list based on user-input constraints; iterating source-destination pairs in the sorted source-destination list to find a shortest routing path from the source to the destination; splitting each source-destination pair to multiple sub source-destination pairs based on one of the user-input constraints; iterating each of the sub source-destination pairs to find a shortest routing path in a sub source-destination list; creating routing table for each sub source-destination pair based on the user-input constraints; combining the routing tables of sub source-destination pairs to generate a source-destination pairs routing table; performing routing table deadlock detection before proceeding to generate a routing table for next source-destination pair; wherein the user-input constraints comprising desired throughput, desired data travelling latency, number of router-turns and region restriction for routing; and wherein performing deadlock analysis and rerouting the source-destination pair if deadlock is detected.

In accordance with an embodiment of the present invention, the computer-implemented method of generating a network-on-chip routing table is utilized to find the shortest path distance from source to destination without visiting all possible routes within a region based on coordinates. Furthermore, this method will generate fast runtime and low memory consumption.

In accordance with an embodiment of the present invention, users shall identify initiator to target pair to indicate the source and destination of the expected traffic flow. Each initiator and target pair translates to two source and destination pairs, preferably initiator to target and target to initiator.

In accordance with an embodiment of the present invention, one of the user-input constraints in splitting each source-destination pair is the region restriction for routing, which is also known as link constraints to restrict the traffic must go through specific paths.

In accordance with an embodiment of the present invention, sorting source-destination list based on user-input constraints comprises sorting in ascending based on latency or sorting in descending based on desired throughout from source to destination.

In accordance with an embodiment of the present invention, creating routing table for each sub source-destination pair based on the user-input constraints comprises the steps of: initializing runtime parameters for the sub source-destination pairs based on the source and destination coordinates; selecting a routing path of the sub source-destination pair that meets the user-input constraints; selecting a next routing path when the routing path reaches sub-destination; confirming the selected next routing path meets the user-input constraints; confirming the selected next routing path reaches the sub-destination; rerouting to find alternative paths within a restricted region if the next routing path is not found; and expanding the restricted region to restart selecting the routing path if the routing path fail to reach sub-destination.

In accordance with an embodiment of the present invention, the runtime parameter shall refer to the user-input constraints to find the most efficient and shortest route between each sub source-destination pairs.

In accordance with an embodiment of the present invention, the user-input constrain, particularly the maximum number of router-turns from the initiator to the target across routers. A router-turn represents the 90° turn within a router, from the input port to the output port of the router.

In accordance with an embodiment of the present invention, a current router is pointed to current located router to indicate that the current router has reached the sub-destination and the routing table generation is completed. More preferably, the current router is also known as an active pointer.

In accordance with an embodiment of the present invention, the user-input constraints and criteria in selecting the next routing path comprises of: selecting a path within the restricted region; selecting a path with sufficient bandwidth and remain lesser bandwidth after used by current iteration; selecting a path that meet with the desired latency in user-input constraint; selecting a path that meet with the desired router-turns in user-input constraint; selecting a path with the same coordinate as previous route; bypassing the coordinate if the current router located at sub-destination coordinate and there is any other undiscovered path; and selecting a path with longer distance to next router, wherein routing seed shall be implemented to cover all permutation when there are multiple paths meet all above criteria for next path.

In accordance with an embodiment of the present invention, the algorithm will immediately give up the current route and discover other possible route if the route does not meet the user-input constraints and criteria at every next route selection.

In accordance with an embodiment of the present invention, rerouting to find alternative paths within the restricted region involves reverse one step back to previous router or beginning of sub-source router.

In accordance with an embodiment of the present invention, expanding the restricted region to restart selecting the routing path also increases the number of router-turns and number of hops.

In accordance with an embodiment of the present invention, deadlock is detected by utilizing Depth First Search algorithm to catch cycle routing path in the routing table.

In accordance with an embodiment of the present invention, performing deadlock analysis and rerouting the source-destination pair comprises the steps of: building a dependency graph based on link and adjacent link from the routing table; identifying cycling path by using the dependency graph to detect the deadlock link and adjacent link; filtering the source-destination pair that contains the deadlock link and adjacent link; and rerouting the source-destination pair by excluding the deadlock link and adjacent link.

In accordance with an embodiment of the present invention, performing deadlock analysis and rerouting the source-destination pair further comprises proceeding to next link and adjacent link if deadlock persist after visiting all routing paths, repeating the step of identifying cycling path.

In accordance with an embodiment of the present invention, the deadlock detected routing table in a deadlock map is stored in hash value.

In accordance with an embodiment of the present invention, the computer-implemented method of the present invention can be applied to generate the routing table in 2D and 3D network-on-chip architectures.

### EXAMPLES

### Example 1: Preparation of Generating a Network-On-Chip Routing Table and Source-Destination List Iteration

As illustrated in FIG. 1, a flowchart of computer-implemented method of generating a Network-on-Chip routing table having preparation phase. The routing table generation method will sort the source-destination list based on user-input constraints. The source-destination with the strictest constraints shall be processed first. The first step in preparation phase is to enter input of the following requirements for routing table generation:
a. Identify source to destination pair based on system application to indicate the origin and endpoint of the expected traffic flow. Each source-destination pair translates to two source and destination pairs which is initiator to target and target to initiator.
b. Specify constraint of each source and destination:
i. Desired throughputs.
ii. Desired latency.
iii. Desired number of router-turns.
iv. Link constraints to restrict the traffic must go through specific paths.

The second step is to sort the source-destination list based on the user specified constraints as follows:
c. Sorted in ascending based on desired latency (low to high)
d. Sorted in descending based on desired throughputs (high to low)
e. Sorted in ascending based on desired number of router-turns (low to high)

The source and destination pairs in sorted list are then iterated.

### Example 2: Routing Algorithm to Find the Shortest Path from Source Router to Destination Router

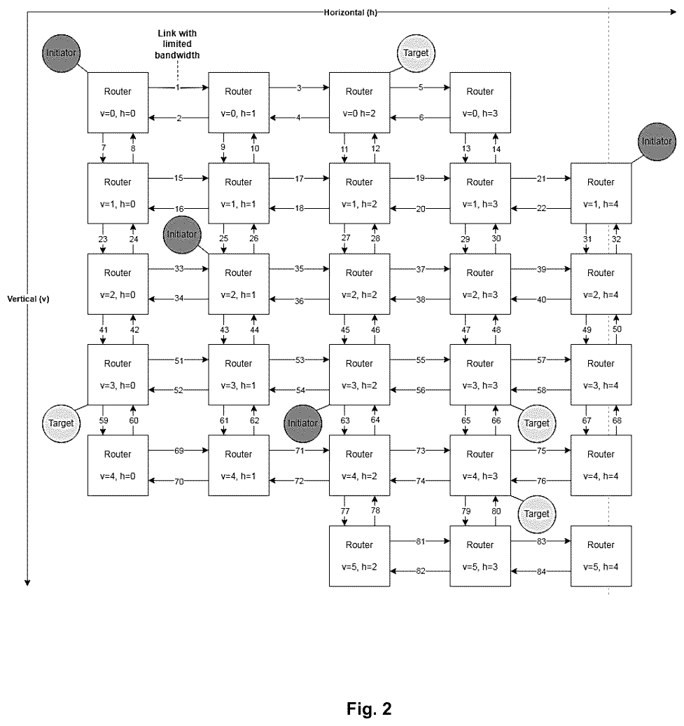

First, the source-destination pair is split into sub source-destination pairs. Sub source-destination pairs indicates the corresponding source and destination routers. Refer to FIG. 2 and Table 1 below as an example of source-destination pair:

If without user specified link constraints, the SUB SRC and DEST list is:

| SUB-SRC-DEST Pair | SUB-SRC | SUB-DEST |
|---|---|---|
| SUB-SRC-DEST #1 | Router [v = 0, h = 0] | Router [v = 3, h = 3] |

If with user specified link constraints “Link 19”, the SUB SRC and DEST list is:

TABLE 1
Sub source-destination list with user-input constraints

| SUB-SRC-DEST Pair | SUB-SRC | SUB-DEST |
|---|---|---|
| SUB-SRC-DEST #1 | Router [v = 0, h = 0] | Router [v = 1, h = 2] |
| SUB-SRC-DEST #2 | Router [v = 1, h = 2] | Router [v = 1, h = 3] |
| SUB-SRC-DEST #3 | Router [v = 1, h = 3] | Router [v = 3, h = 3] |

Then, all sub source-destination pairs in the sub source-destination list is iterated to find the shortest path.

Afterwards, all the runtime parameters for current sub source-destination pair is initialized based on router coordinate. The routing algorithm shall refer to the desired parameters value to find the most efficient route. The desired maximum hops indicate the maximum number of routers to go through from source to destination. Therefore, a formula to calculate the desired maximum hop based on coordinate is as below:

Formula to calculate the desired maximum hops:

Distance v=DEST(v)−SRC(v)

Distance h=DEST(h)−SRC(h)
Desired maximum hops=Sum of distance v, h

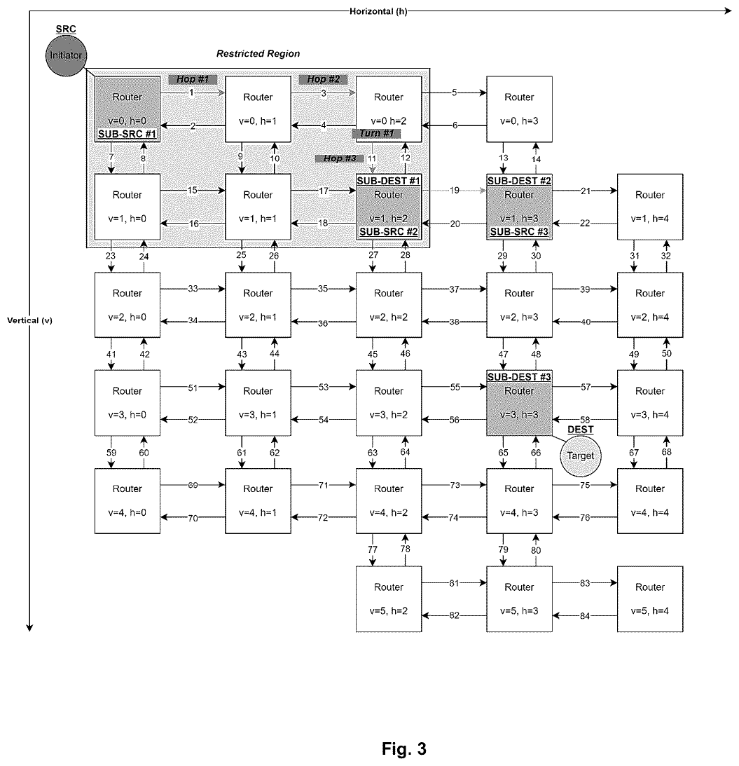

Referring to FIG. 3, the use of formula to calculate the desire maximum hop is as below:

SUB-SRC #1 [v=0,h=0],SUB-DEST #1 [v=1,h=2]

Distance v: 1−0=1

Distance h: 2−0=2

Desired maximum hops: 1+2=3

Aside from that, the desired parameter value of router turns is formulated as minimum number of router-turns is equivalent to number of different coordinates subtracted by 1.

Router-turn represents the 90° turn within a router, for example input from east or west port, output to north or south port and input from north or south, output to east or west.

Referring to FIG. 3, the use of formula to the desired minimum number of router-turns is as below:
If both coordinates (v, h) are different, minimum 1 turn is required.
If only 1 coordinate is different, expects 0 turns.
If all coordinates are the same, means both SRC and DEST are at same router.
SUB-SRC #1 [v=0, h=0], SUB-DEST #1 [v=1, h=2]
Both coordinates (v, h) are different, thus, number of different coordinates is 2.
Desired router-turns: 2−1=1

The routing algorithm shall find the path within the restricted region only by default. The region will only be expanded during restart route if failed to reach destination after visiting all paths in the restricted region. In typical use cases, the shortest path should be found within the default region.

Referring to FIG. 3, the restricted region is within the range of maximum distance in coordinate from source router to destination router. The example is as below:
SUB-SRC #1[v=0, h=0], SUB-DEST #1[v=1, h=2]
The restricted region is:
   Range of v: coordinate 0 to 1
   Range of h: coordinate 0 to 2

After that, selecting next path is required wherein “SUB-SRC” and “SUB-DEST” represent the source and destination router of current iteration. “CUR” is the active pointer that point to current located router. “CUR” is “SUB-SRC” at beginning, it will move to become next router after selecting the next path. When “CUR” is “SUB-DEST”, it means the routing table generation is completed and it has reached destination. “CUR (h or v)” represents coordinate of h or v of CUR router.

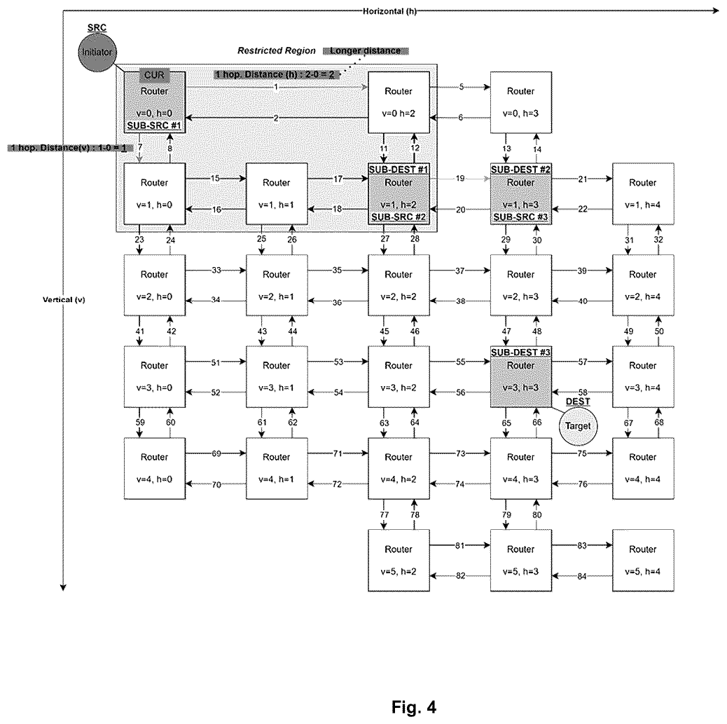

As illustrated in FIG. 4, the algorithm discovers and selects the next path based on the following criteria:
1. Selecting the path within the restricted region.
2. Selecting the path with adequate bandwidth and remain lesser bandwidth after being utilized by the current iteration. The algorithm shall fully utilizes the link before opting for an alternative, thus optimizing the utilization of hardware resources. For example, if the SRC and DEST user specified throughput is 10 GBps and there are two paths have sufficient bandwidth, path A has 20 GBps, path B has 12 GBps. It is recommended to prioritize the selection of path B.
3. Selecting the path that able to meet user specified latency requirement.
4. Selecting the next path with same coordinate as previous move to minimize the number of router-turns while move forward. For example, if previous move is from east to west or west to east, means it is moving on horizontal index. If CUR (h)<SUB-DEST (h), continue move CUR to next router at h+1. If CUR (h)>SUB-DEST (h), continue move CUR to next router at h−1.
5. Bypassing the coordinate if the coordinates match between CUR and SUB-DEST and there exists another undiscovered path. For example, if CUR (v)=SUB-DEST (v), which means they are on the same vertical index. It is recommended select the path that move to next router on different h coordinate.
6. Selecting the path which has longer distance to next router to reduce hop count.
7. Implementing routing seed to cover all permutations when there are multiple paths meet all above criteria for next path.

The route is then continually verified to ensure it complies with the user-input constraints at each step when moving to the next router, rather than waiting until the end. The algorithm has the capability to immediately give up the current route and explore other potential routes. Subsequently, it is checked to confirm whether it has reached the destination by verifying if current router location is equal to sub destination router location.

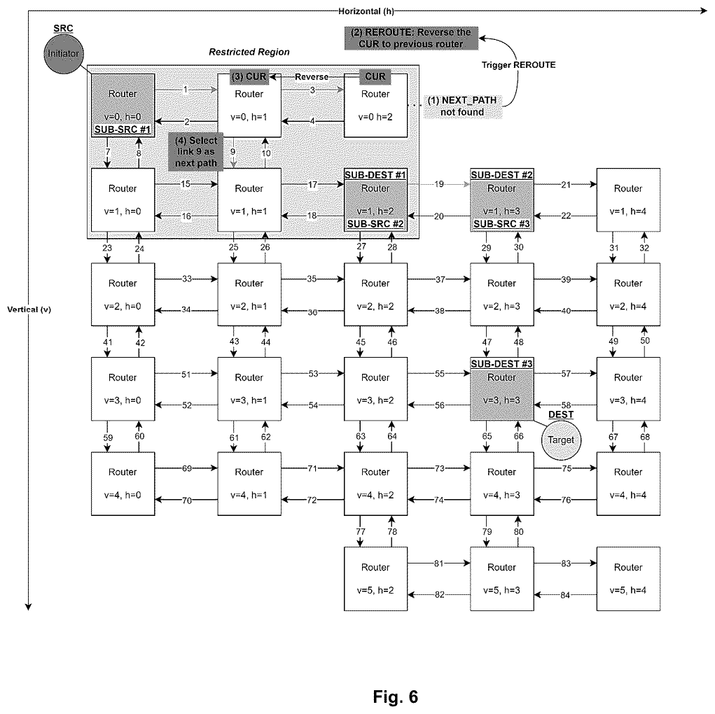

If the next path is failed to be found, reroute will be carried out to discover the alternative paths within same region, which means reverse back to earlier router that has undiscovered path. Referring to FIG. 6, it shows that the current router is reversed to previous router that has undiscovered path. Routing seed can be implemented in this step to decide the previous router for reroute. It can reverse one move to previous router or reverse all the way to the beginning router. The current router will be reversed back from router [v=0, h=2] to router [v=0, h=1] and find the next path again in the undiscovered path.

If the algorithm has visited all route within the restricted region but still not able to reach sub destination, it will expand the region and increase the desired number of router-turns and hop accordingly and restart the path finding.

The expansion of region comprises criteria characterized as follows:
If (SRC (v)==DST (v)), expand v by increasing one, use routing seed to decide west (v−1) or east (v+1);
If (SRC (h)==DST (h)), expand h by increasing one, use routing seed to decide north (h−1) or south (h+1); and

If does not match all above, use routing seed to decide the region expansion on p or v or h, wherein p refers to planar direction in 3D Network-on-Chip architectures, v refers to vertical direction and h refers to horizontal direction in both 2D and 3D Network-on-Chip architectures.

Aside from that, the increase of the number of turns and hop based on the expansion characterized as follows:

Plus two for desired number of router-turns and cap at user specified maximum turns.

If the restricted region expands vertically, the desired additional number of hops is the distance between the maximum and minimum “h” of the new region, plus 2.

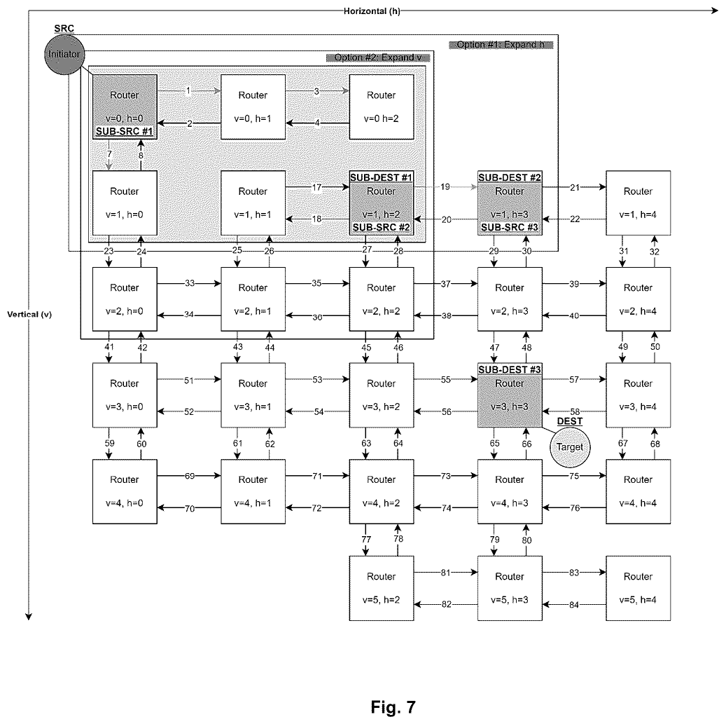

If the restricted region expands horizontally, the desired additional number of hops is the distance between the maximum and minimum “v” of the new region, plus 2 Referring to FIG. 7 as an example, utilize the routing seed to determine whether to choose option #1 (expand vertically) or option #2 (expand horizontally).

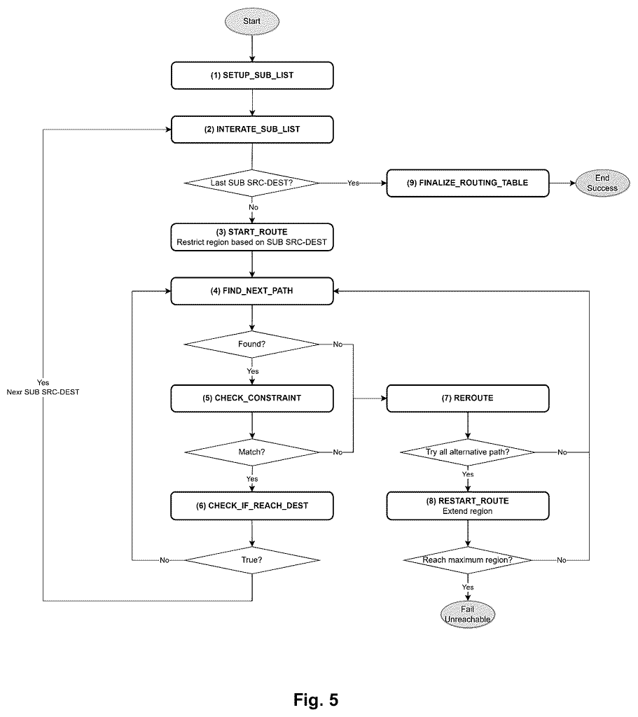

Finally, the routes of all sub source-destination pairs are combined to become the final routing table for source-destination pair. Said processes in this example is illustrated in FIG. 5

### Example 3: Deadlock Detection and Deadlock Analysis and Reroute

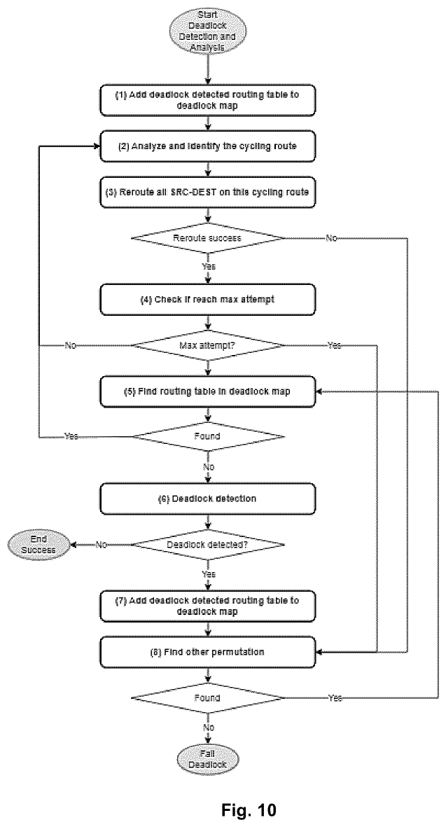

Deadlock detection is performed after generating the source-destination pairs routing table and before generating the next source-destination pairs routing table. In other words, deadlock detection in the routing table is performed in stages rather than being performed once at the end. As illustrated in FIG. 10, if deadlock is detected, deadlock analysis and reroute method is performed to solve the deadlock issue before proceeding to generate routing table for next source-destination pairs.

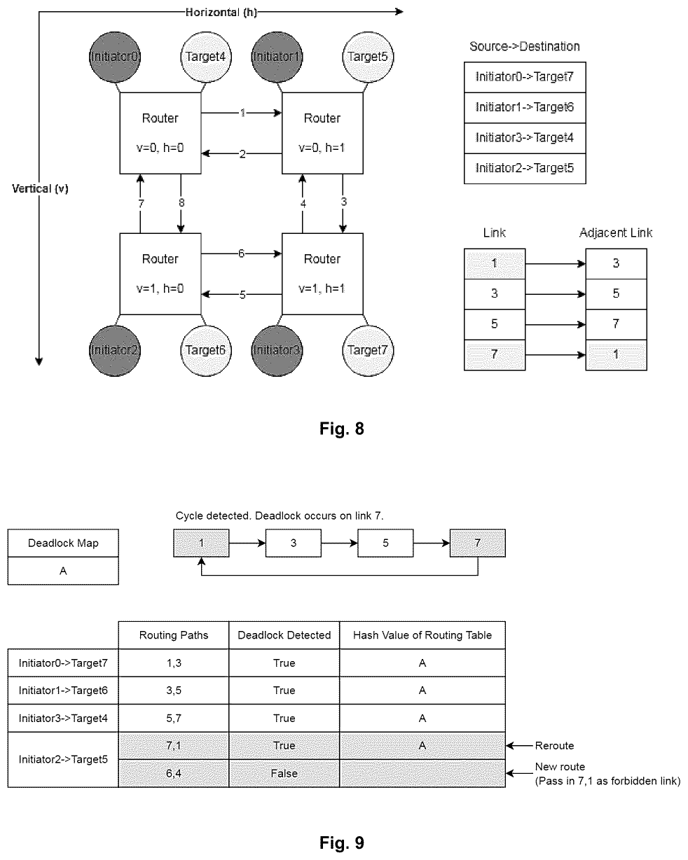

Depth first search (DFS) or also known as Depth First Traversal algorithm has been chosen to catch the cycle routing path in the routing table. The cycle routing will cause deadlock when the buffer is full on all nodes. Dependency graph will be built based on link and its adjacent link from routing table. Deadlock occurred if the location has been visited twice using DFS algorithm. FIG. 8 illustrates the dependency graph with the deadlock will be detected on link 7.

Deadlock map in deadlock analysis is utilized to store the deadlock detected routing table in hash value which will be used to bypass the routing table during reroute process. Once the deadlock is detected, the deadlock analysis is performed by the step of: identify where the cycling path happened, filtering the source-destination pair that contains the deadlock link and adjacent link and rerouting the source-destination pair by excluding the deadlock link and adjacent link. Referring to FIG. 9 as an example, the deadlock is detected on link 7 and its adjacent link which is link 1. All the source-destination pairs that contains link 7 and 1 in the routing table will be filtered out. In this example, Initiator 2-Target 5 pair has been filtered out. In the next step, Initiator 2-Target 5 pair will be rerouted by excluding link 7 and 1 to make sure it chooses other paths.

If a deadlock persists after visiting all routing paths, move to the next link and its adjacent link, repeating the step of identifying the cycling path and filtering the source-destination pair that contains the deadlock link and adjacent link. If deadlocks are still detected after all links and their adjacent links within the cycling chain have been tried, a permutation process is initiated. This process iterates through all source-destination pairs again to create routing paths, exploring other potential alternatives. Subsequently, it attempts permutations of all routing path possibilities for all source-destination pairs. As this process is resource-intensive, it is essential to always check the deadlock map for the existence of a routing table before executing the deadlock detection algorithm.

The present invention overcomes the shortcoming of the prior arts by providing region-based and deadlock-free routing table generation method to find the shortest path from initiator to target without visiting all possible routes preferably utilized user-input constraints including desired throughput, desired data travelling latency, desired maximum router turns and desired link constraints. The routing table generation method in the present invention helps to reduce runtime and memory consumption.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

1. A computer-implemented method of generating a Network-on-Chip routing table, said method comprising the steps of:
identifying source and destination by coordinates;
sorting source-destination list based on user-input constraints;
iterating source-destination pairs in the sorted source-destination list to find a shortest routing path from the source to the destination;
splitting each source-destination pair to multiple sub source-destination pairs based on one of the user-input constraints;
iterating each of the sub source-destination pairs to find a shortest routing path in a sub source-destination list
creating routing table for each sub source-destination pair based on the user-input constraints;
combining the routing tables of sub source-destination pairs to generate a source-destination pairs routing table; and
performing routing table deadlock detection before proceeding to generate a routing table for next source-destination pair;
wherein the user-input constraints comprising desired throughputs, desired data travelling latency, number of router-turns and region restriction for routing;
wherein performing deadlock analysis and rerouting the source-destination pair if deadlock is detected.

2. The computer-implemented method as claimed in claim 1, wherein creating routing table for each sub source-destination pair based on the user-input constraints comprises the steps of:
initializing runtime parameters for the sub source-destination pairs based on the source and destination coordinates;
selecting a routing path of the sub source-destination pair that meets the user-input constraints;
selecting a next routing path when the routing path reaches sub-destination;
confirming the selected next routing path meets the user-input constraints;
confirming the selected next routing path reaches the sub-destination;
rerouting to find alternative paths within a restricted region if the next routing path is not found; and
expanding the restricted region to restart selecting the routing path if the routing path fail to reach sub-destination.

3. The computer-implemented method as claimed in claim 1, wherein the user-input constraints further comprise number of hops.

4. The computer-implemented method as claimed in claim 1, wherein one of the user-input constraints in splitting each source-destination pair is the region restriction for routing.

5. The computer-implemented method as claimed in claim 1, wherein sorting source-destination list based on user-input constraints comprises sorting in ascending based on desired latency or sorting in descending based on desired throughputs.

6. The computer-implemented method as claimed in claim 2, wherein rerouting to find alternative paths within the restricted region involves reverse one step back to previous router or beginning of sub-source router.

7. The computer-implemented method as claimed in claim 1, wherein deadlock is detected by utilizing Depth First Search algorithm to catch cycle routing path in the routing table.

8. The computer-implemented method as claimed in claim 1, wherein
performing deadlock analysis and rerouting the source-destination pair comprises the steps of:
building a dependency graph based on link and adjacent link from the routing table;
identifying cycling path by using the dependency graph to detect the deadlock link and adjacent link;
filtering the source-destination pair that contains the deadlock link and adjacent link; and
rerouting the source-destination pair by excluding the deadlock link and adjacent link.

9. The computer-implemented method as claimed in claim 8 further comprises proceeding to next link and adjacent link if deadlock persist after visiting all routing paths, repeating the step of identifying cycling path.

10. The computer-implemented method as claimed in claim 8, wherein storing the deadlock detected routing table in a deadlock map in hash value.

11. A computer program comprising instructions for implementing a method for generating a network-on-chip routing table as claimed in claim 1.

12. The computer-implemented method as claimed in claim 1, wherein storing the deadlock detected routing table in a deadlock map in hash value.
